(19) United States
(12) Patent Application Publication
(10) Pub. No.: US 2007/0026765 A1
(43) Pub. Date: Feb. 1, 2007

(54) Composition and method for the control of parasitic mites of honey bees

(76) Inventor: Richard Martin Renn, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/496,391

(22) Filed: Jul. 31, 2006

Related U.S. Application Data
(60) Provisional application No. 60/704,682, filed on Aug. 1, 2005.

(51) Int. Cl. A01K 51/00

(52) U.S. Cl. 449/2

(57) ABSTRACT

The present invention is directed to a composition and method of its use for controlling parasitic mites of honey bees. The miticide composition comprises a miticidally effective amount of one or more essential oils mixed with a dispersing agent, such as an organic and/or synthetic surfactant or emulsifier, and a water-based solution. Preferably, the water-based solution is a bee feed, such as those made from water and sugar, corn syrup and/or honey. A pH adjusting agent, such as an acid or buffer, can be utilized as needed. The miticide composition is sprayed into the bee hive to coat the bars, frames, comb and bees, as well as any mites therein. Contacting the mites with the composition kills them. The spraying also stimulates the bees grooming each other and themselves. The miticide composition is fed to the bees so any mites that feed on the bees are exposed to the composition.

### CROSS-REFERENCE TO RELATED APPLICATIONS

This application claims the benefit of U.S. Provisional Application No. 60/704,682 filed Aug. 1, 2005.

### BACKGROUND OF THE INVENTION

A. Field of the Invention

The field of the present invention relates generally to compositions and methods for controlling parasitic mites of honey bees. More particularly, the present invention relates to such compositions in which the miticidally active compound is comprised of one or more essential oils and organic or synthetic surfactants or emulsifiers and relates to methods of applying such compositions to control mites of honey bees. Even more particularly, this invention relates to methods of applying such compositions in which the compound is sprayed or combined with a bee feed.

B. Background

Honeybees are of the Order Hymenoptera and include the species Apis florae (dwarf honeybee), Apis dorsata (giant honeybee), Apis cerana (Asian honeybee), Apis mellifera (common, European and African honeybee), and Apis laboriosa (Nepal honeybee). In addition to their importance in the United States as pollinators for many crops, honeybees also produce honey, wax, and royal jelly, and collect pollen and propolis. Of the many pests that infest honeybees, the Varroa (Varroa jacobsoni) mite is one of the most threatening problems facing beekeepers. This mite feeds on the blood of honeybees in all stages of bee development, preferring brood. Because this mite normally attaches itself on top of the thorax near the wings, between the head and thorax, between the thorax and abdomen or between the overlapping segments of the abdomen, it is not easily or normally removed by the bees during their normal grooming rituals. Not only does the mite feed on adult bees, pupae, and larvae, but it is also a vector for disease. For instance, it is known that mites transmit viruses to honeybees, which can substantially weaken the colony. In addition, at least one researcher has suggested that these mites also transmit bacteria. Damage to mite infested honeybee larvae can range from no visible damage to death before they develop enough to emerge from the cell. When a colony of bees is heavily infested, the damage done by the mite can cause the death of the colony.

There are several methods currently used to treat Varroa mites. One of these methods relies on the mites' attraction to drone brood. Drone comb is different from regular comb, and so is easily recognized and separated from other comb in the hive. It can be introduced into the hive in the spring where the queen will then lay drone eggs in it. The resulting brood acts as a magnet for Varroa mites. The beekeeper can then remove this comb and kill the mites by freezing the frames. This method of controlling parasitic mites of honey bees is most effective in early spring.

Another method of controlling Varroa mites is the use of miticide compounds and delivery systems for contacting the mites with the miticide. One such compound and system is Apistan®, which is a plastic strip impregnated with the miticide fluvalinate. These plastic strips are placed between the frames where they are most likely to come into contact with the mites. This method cannot be used when honey supers are on the hive. Also, the strips must be removed not more than eight weeks after they are inserted, requiring the beekeeper to open every hive a second time. Resistance to this method of control was detected in the United States in 1997. A more recently developed method of control is Coumaphos (CheckMite+Strips), which was approved in January of 1999 as an emergency response to Apistan® resistance. This miticide is also used in the form of a plastic strip hung between frames. Due to the potency of the active chemicals, proper protection must be worn by the beekeeper to prevent absorption of this chemical through his or her skin. Formic acid was also approved in 1999 as a control method for Varroa mites. It is sold and used in gel packs that are applied to the top bars of hives in late summer and early fall. Because it is a fumigant, formic acid will not work if the temperature is too cold for the compound to evaporate. Proper protection must also be used with formic acid as it can damage the skin and lungs. Apiguard™ is a registered fumigant in Europe and mentions control of Varroa destructor and Varroa jacobsoni oudemans. This product is formed as a thymol containing gel in an aluminum container with a peel off lid and is provided in individual packets that are placed in the hive. Depending on the condition of the beekeeping equipment in use, fumigants may evaporate too rapidly for sufficient treatment (i.e., old equipment that is not air tight, very hot days).

Another alternative method of controlling Varroa mite involves manipulating the genetics of the honeybees. Bee breeders are currently trying to develop mite resistant (Suppressed Mite Reproduction or “SMR”) bees. Unfortunately, as with any genetic manipulation, selecting bees for this genetic quality may lead to the loss of other desirable traits. In addition to taking years to develop the strain of bees, there have been problems with some colonies accepting SMR queens. Maintaining the genetic purity of this stock/strain will also be difficult and time-consuming, as controlling the breeding of bees requires meticulous attention and is labor intensive and most beekeepers cannot or will not devote sufficient time to this task.

While not presently utilized for control of mites, certain chemical compounds are known to be significantly less hazardous to humans and bees than the chemicals set forth above. One group of such chemicals are known as essential oils, which include cinnamon oil, citronella oil, lemongrass oil, mint oil, rosemary oil, spearmint oil and peppermint oil. The United States Environmental Protection Agency (“EPA”) has exempted these essential oils from the regulatory requirements of the Federal Insecticide, Fungicide and Rodenticide Act (“FIFRA”). The EPA allows various listed inert substances can be added to the compounds having essential oils as the active ingredient. These inert substances include cloves, mineral oil, paraffin wax and wintergreen oil. Although there is some current use of essential oils in water, resin blocks and feeds, these have not been heretofore available to beekeepers as a form of mite control. One problem for such use is that essential oils do not dissolve in water-based mixtures (i.e., sugar-syrup solutions) and there is a problem with the essential oil being drawn to itself and forming pockets of higher concentration that can kill bees upon contact. Conversely, areas of such solutions that have very low or no essential oil, because it has been drawn elsewhere in the solution, will not serve any beneficial use to kill or control mites.

Despite the forgoing compositions and methods for controlling parasitic mites of honey bees, what is needed is an improved composition and method that overcomes the limitations and does not have the disadvantages of the currently available compositions and methods. The preferred composition and method should use readily available and generally safe to use compounds that will not present significant danger to the bee handler or the bees. The preferred method of treating bees to control parasitic mites should be more effective at ensuring all aspects of the bee hive and bees are treated for these mites.

### SUMMARY OF THE INVENTION

The composition and method for the control of parasitic mites of honey bees of the present invention provides the benefits and solves the problems identified above. That is to say, the present invention discloses a composition and method for the control of mites in honey bees utilizes readily available chemicals that are well known not to present significant danger to the bee handler or the bees. The composition and method of the present invention will more effectively treat all aspects of the bee hive and bees for the presence of mites, thereby substantially reducing or eliminating the problem of mite infestation in the bee hive.

The two fundamental aspects of this invention are forcing the bees to groom each other and themselves by spraying them with a miticidally effective amount of the compound of the present invention and introducing the miticidally effective compound into the food supply of the hive. With regard to the first aspect of the present invention, which involves spraying the bees with a compound containing an essential oil, it has not been seen before. The second aspect, feeding the bees an essential oil, has been seen and done before. However, what makes the present invention new and unique is that it uses an emulsifier or surfactant mixed with the essential oil. When previously discussed and used, the essential oil was placed in the bee feed without an emulsifier or surfactant. As stated above, this has caused many problems as the oil does not disperse evenly in the water and areas of higher and lower concentration occur. The areas of higher concentration can cause mortality in the bees that come into contact with the feed and the areas of lower concentration are not usually miticidally effective. Both of these problems are eliminated when a surfactant or emulsifier is utilized in the compound of the present invention.

Getting the miticide into the food supply of the bee hive is important because this is one of the easiest ways to get the miticide into the bee larvae, where the Varroa mites will come into contact with it when they try to feed. As mites develop from egg to adult by feeding on the honeybee larvae inside the cell, this is one of the most effective ways to control them. The mites are prevented from maturing, thereby doing minimal damage to the colony of bees.

Another mechanism of mite control that is utilized by this invention is grooming. Those strains of honey bees that sustain less damage from mite infestations have been shown to be those that perform grooming more often. Increased grooming within a colony has been shown to be effective for the control of both tracheal (Acarpis woodi) and Varroa mites. Spraying bees with sugar water or another bee feed forces them to groom themselves and each other. In this manner, mites are physically removed.

One advantage of the method of control used in this invention is that it does not require the labor intensive addition and removal of frames that could otherwise be used in the colony for brood production and feed storage. All of the beekeeper's equipment can be in use at all times. Also, the method of spraying the bees has multiple modes of action, both an element that is toxic to mites and the stimulation of bees to groom each other in such a manner that promotes the removal of mites. This means that the development of resistance to this method is less likely than one that relies on only one mode of action. Another likely consideration is that the essential oils of the composition may inhibit mite growth by masking the scents in the hive, preventing mites from being able to effectively detect hosts.

Another benefit to the user of this invention is that no special protection needs to be worn by the beekeeper to apply this method of control. All ingredients are safe to humans at the intended levels of use. The miticidally effective compound used in this method of control can be prepared and transported in bulk quantities.

Another aspect that contributes to the efficacy of the method of mite control embodied by this invention is the direct contact of the miticide with the bees. The bees are sprayed directly and the essential oils enter the food supply in the hive, so, unlike plastic strips that the bees must come into contact with or fumigants that may not work if the colony is clustered too far from the source of the fumigant, contact with the miticide and treatment throughout the hive is more assured.

Accordingly, the primary objective of the present invention is to provide an improved composition and method for controlling parasitic mites of honey bees that provides the benefits described above and solves the problems presently associated with present compositions and methods of controlling such mites.

Specifically, it is a primary objective of the present invention to provide a composition for controlling parasitic mites of honey bees in which the miticidally active compound comprises one or more essential oils mixed with an organic or synthetic surfactant or emulsifier and a method for applying such composition to bees and bee hives for the treatment of mites.

It is also an objective of the present invention to provide a method of controlling parasitic mites of honey bees that includes the step of spraying a miticidally effective compound into the hive, onto the top bars, into the brood nest, onto the bees, onto the frames and comb of the hive and/or anywhere else it may be necessary so as to wet the hive and bees with the composition.

It is also an objective of the present invention to provide a method of controlling parasitic mites of honey bees that includes the step of combining the miticidally effective compound with a bee feed which is then fed to the bees or used as the sprayed composition.

The above and other objectives of the present invention will be explained in greater detail by reference to the description of the preferred embodiment which follows. As set forth herein, the present invention resides in the novel features of form, construction, mode of operation and combination of processes presently described and understood by the claims.

### DETAILED DESCRIPTION OF THE PREFERRED EMBODIMENTS

The preferred embodiments of the present invention are set forth below. Although specific components, materials, configurations and uses are discussed herein, it should be understood that a number of variations to the components and application of those components can be made without changing the scope and function of the invention set forth herein. For purposes of simplifying this disclosure, the discussion and references herein are generally to use of the present invention with regard to honey bees. Those skilled in the art, however, will understand and appreciate that the composition and method disclosed herein is not so limited, namely that it may be useful for controlling mites of other types of bees.

The composition and method of the present invention generally comprises a chemical compound containing a miticidally effective amount of one or more essential oils combined with a dispersing agent, such as organic and/or synthetic surfactants or emulsifiers, in a water-based solution. A pH adjusting agent, such as acids or buffers, are utilized where they are needed to adjust the pH so as to provide a more compositionally consistent and stable compound. The miticidally active ingredient in the composition of the present invention is the essential oil(s). The miticidally effective amount of essential oil is combined with surfactants or emulsifiers in a water-based solution, which will preferably be a bee feed. Bee feed suitable for the composition of the present invention include those prepared as a syrup from water and sugar, corn syrup and/or honey. The surfactant or emulsifier serves to evenly disperse the essential oil(s) in the composition, so as to reduce toxicity from areas of high concentration and to ensure more even exposure to the mites to improve the efficacy of the treatment. The pH adjusting agent (i.e., an acid or buffer) may be used to ensure that the pH is low enough to keep the solution at an optimum consistency and clarity.

Essential oils for use with composition and method of the present invention include wintergreen oil, cinnamon oil, citronella oil, lemongrass oil, mint oil, rosemary oil, spearmint oil and peppermint oil (as well as others exempted by the EPA from the FIFRA requirements). As reported by those skilled in the art, essential oils have been shown to have miticidal effects, with mite mortalities as high as 97% with concentrations of essential oils at approximately 2 g/100 g. These same essential oils are also known to be only minimally toxic to honeybees. In addition, as reported by others in the industry, essential oil accumulation in wax does not occur and the essential oil residues in honey are small and toxicologically not important. As such, essential oils are safe for the bees, beekeepers and the products produced by the bees.

To formulate the composition of the present invention, a miticidally effective amount of one or more essential oil(s) is mixed with a surfactant or emulsifier (whether synthetic and/or organic) in a water-based solution, with acid or buffer added where necessary, in known concentrations in a suitable container. As stated above, the preferred water-based solution comprises a known, bee-safe feed material, such as corn syrup. If desired, the mixed composition can be stored and transported in the same container utilized for formulation. The composition is then prepared for application in the form of a spray or a feed.

If prepared for spraying, the solution is placed into a sprayer (any type, an example is a garden sprayer). The bees are then sprayed by opening the lid of the hive to expose the bees and the top frames and then using the sprayer to wet the top bars, frames, bees, comb, and/or brood nest of the hive and any mites therein. If the colony is multistage, then the user cracks the hives apart to spray each level, especially to make sure that contact is made with those frames where the brood nest is located (while still spraying the top bars directly beneath the lid). The sprayer should be adjusted so that it sprays more of a mist than a stream of the composition, but not so much of a mist that excessive amounts of the composition are lost in the air. Generally, this requires that enough of the composition be sprayed so that droplets begin to form on the wooden surfaces of the hive (i.e., the composition puddles slightly on the top bars). The objective of the spraying is to kill mites on contact with the miticide composition and to stimulate the bees grooming each other and themselves. A limitation to the foregoing spraying method is that the bees cannot be sprayed below temperatures of approximately 58-60 degrees Fahrenheit, as it is likely to be too cold for the bees to clean themselves quickly enough to prevent death.

If the miticide composition of the present invention is prepared as a bee feed to be fed to the bees, the composition is placed in a feeder accessible to the bees, such as but not limited to gravity feeders (i.e., jar feeders that have holes in the lids and are placed upside down on the tops of hives with a hole in the lid of the hive) or inverted pail feeders, that allow the bees to access the feed from within the hive while not coming into contact with the surface of the feed in the feed container in a manner that could result in the bees drowning. Feeders that are configured to allow the bees to come into contact with the surface of the feed, such as open surface feeders, are not suitable because the surfactants and emulsifiers lower the surface tension of the liquid to lower than that of regular syrup and the bees are likely to fall into the feed more easily, thereby causing a higher instance of drowning. Mites that feed on the bees that are fed with the miticide composition of the present invention will be exposed to the compound.

The aforementioned methods of applying the composition of the present invention (i.e., spraying into the hives and feeding), are primarily intended for hive maintenance and mite infestation prevention. For control of an actual serious infestation, removal of each frame, especially those containing brood, so that each side can be sprayed is likely to be necessary. In this circumstance, enough of the composition should be sprayed onto the bees to lightly coat them with the composition.

The method of manufacturing the composition of the present invention requires a miticidally effective amount of one or more essential oils to be mixed with a suitable dispersing agent (i.e., the emulsifier or surfactant) and then stirred or shaken vigorously. The bee feed, such as sugar and water syrup, corn syrup, honey or etc., is either obtained or prepared and acid, if its use is necessary or desirable, is combined with the bee feed and then mixed well. The essential oil and emulsifier/surfactant mixture is then added to the bee feed (as mixed with acid if applicable). Once the composition is mixed together, it is put into feeder jars and fed to the bees or placed in a sprayer and sprayed onto the top bars of frames with adhering bees until puddles form on the top bars and/or into the hive in an amount sufficient to coat the bees and contact any mites. For heavy infestations, the bee hive is treated as previously described.

In summary, the essential oil is toxic to the mites and is effective in their control. The mites that come into contact with the composition of the present invention by having it sprayed on them or by feeding on bees that have consumed the oil through the syrup or other bee feed will be exposed to the compound. In addition, the grooming behavior stimulated by spraying the bees with the present miticide composition prompts the bees to clean each other and themselves, resulting in removal of mites.

One of the primary benefits of the composition and method of the present invention is that they do not require the labor intensive addition and removal of frames that could otherwise be used in the colony for brood production and feed storage, thereby allowing all of the beekeeper's equipment to be in use at all times. Another primary benefit to the miticide composition and method of the present invention is that there is no known resistance to the chemicals. In fact, the method of control that stimulates the bees to groom each other or themselves more completely to promote the removal of mites is not likely to develop any resistance. Because the method has multiple modes of action, that being toxic to the mites and stimulating the bees to groom, it is much less likely that resistant strains will arise. Another benefit of the present invention is that because the ingredients of the composition are safe to humans at the intended concentration, no special protection or equipment needs to be worn by the beekeeper when applying the composition or performing the method of the present invention. The composition and method are an improvement over existing compositions and methods because the bees are sprayed directly and the essential oils enter the food supply in the hive, thereby ensuring the treatment is better distributed throughout the hive and eliminating the need for the bee to come into contact with a plastic strip or the problem of fumigants being positioned too far from the clustered colony. In addition, the impact of the condition of the beekeeper's equipment (i.e., not air tight or really hot days) is substantially eliminated. Another benefit of the present invention is that bees do not need to be genetically selected or bred to be susceptible to this treatment. The miticide composition and method of the present invention involving spraying the bees with the composition reduces waste by eliminating the use of individual packages, which also reduces time by eliminating the need to open each package.

While there are shown and described herein a specific form of the invention, it will be readily apparent to those skilled in the art that the invention is not so limited, but is susceptible to various modifications and rearrangements in materials and processes without departing from the spirit and scope of the invention. In particular, there are various chemical components described herein that can be replaced with equivalent functioning components to accomplish the objectives of the present invention.

What is claimed is:

1. A miticide composition for controlling parasitic mites of honey bees consisting essentially of a miticidally effective amount of one or more essential oils, a dispersing agent selected from the group consisting of organic and/or synthetic surfactants and emulsifiers, and a water-based solution.

2. The miticide composition according to claim 1, wherein said essential oil is selected from the group consisting of wintergreen oil, cinnamon oil, citronella oil, lemongrass oil, mint oil, rosemary oil, spearmint oil and peppermint oil.

3. The miticide composition according to claim 1, wherein said essential oil is selected so as to be exempt from federal regulatory requirements.

4. The miticide composition according to claim 1, wherein the water-based solution is a bee feed.

5. The miticide composition according to claim 4, wherein the bee feed comprises water mixed with sugar, corn syrup and/or honey.

6. The miticide composition according to claim 1 further comprising a pH adjusting agent.

7. A method of controlling parasitic mites of honey bees, said method comprising spraying said honey bees with a miticide composition consisting essentially of a miticidally effective amount of one or more essential oils, a dispersing agent selected from the group consisting of organic and/or synthetic surfactants and emulsifiers, and a water-based solution.

8. The method according to claim 7, wherein said essential oil is selected from the group consisting of wintergreen oil, cinnamon oil, citronella oil, lemongrass oil, mint oil, rosemary oil, spearmint oil and peppermint oil.

9. The method according to claim 7, wherein the water-based solution is a bee feed.

10. The method according to claim 9, wherein the bee feed comprises water mixed with sugar, corn syrup and/or honey.

11. The method according to claim 7, wherein said miticide composition further comprises a pH adjusting agent.

12. The method according to claim 7 further comprising the steps of mixing said miticidally effective amount of essential oil, dispersing agent and water-based solution together to formulate said miticide composition and placing said miticide composition into a sprayer prior to said spraying step.

13. The method according to claim 7 further comprising the step of opening a bee hive to expose said honey bees prior to said spraying step, said spraying step further comprising spraying a sufficient amount of said miticide composition to wet the hive, bees and mites with said miticide compound.

14. The method according to claim 7, wherein said spraying step further comprises spraying a sufficient amount of said miticide composition to stimulate grooming by said honey bees.

15. A method of controlling parasitic mites of honey bees, said method comprising feeding said honey bees with a miticide composition consisting essentially of a miticidally effective amount of one or more essential oils, a dispersing agent selected from the group consisting of organic and/or synthetic surfactants and emulsifiers, and a water-based solution.

16. The method according to claim 15, wherein said essential oil is selected from the group consisting of wintergreen oil, cinnamon oil, citronella oil, lemongrass oil, mint oil, rosemary oil, spearmint oil and peppermint oil.

17. The method according to claim 15, wherein the water-based solution is a bee feed.

18. The method according to claim 17, wherein the bee feed comprises water mixed with sugar, corn syrup and/or honey.

19. The method according to claim 15, wherein the miticide composition further comprises a pH adjusting agent.

20. The method according to claim 15 further comprising the steps of mixing said miticidally effective amount of essential oil, dispersing agent and water-based solution together to formulate said miticide composition and placing said miticide composition into a feeder, said feeder configured to allow said honey bees access to said miticide composition without drowning.
